(19) United States
(12) Patent Application Publication
(10) Pub. No.: US 2012/0254872 A1
(43) Pub. Date: Oct. 4, 2012

(54) Content Items for Scientific Data Information Systems

(75) Inventors: Mihaela Lupu, Brazov (RO); Andreas Wintergalen, Pulheim (DE)

(73) Assignee: WATERS TECHNOLOGIES CORPORATION, Milford, MA (US)

(21) Appl. No.: 13/435,200

(22) Filed: Mar. 30, 2012

Related U.S. Application Data
(60) Provisional application No. 61/479,218, filed on Apr. 26, 2011.

(30) Foreign Application Priority Data
Apr. 1, 2011 (EP) 11002765.3

(51) Int. Cl. G06F 9/44; G06F 17/30

(52) U.S. Cl. 718/100; 707/792; 707/E17.033

(57) ABSTRACT

Data information systems include memory for storing a first content item representing a predefined workflow. The first content item has a data format that complies with a unified data structure. The data information system further comprises a scientific instrument configured to acquire data in accordance with the predefined workflow, and a server in communication with the scientific instrument to obtain the data acquired by the scientific instrument. The server has a processor that executes program code to convert the acquired data into a second content item with a data format that complies with the unified data structure. The unified data structure can include an instance data element with fields that are specific to a type of content item, and a catalog data element having a copy of data extracted from the type-specific fields of the instance data element.

### RELATED APPLICATIONS

This application claims priority to and benefit of U.S. Provisional Patent Application Ser. No. 61/479,218, filed on Apr. 26, 2011, and priority to and benefit of European Patent Application No. EP 11 002 765.3, filed on Apr. 1, 2011. The entire contents of these applications are incorporated herein by reference.

### TECHNICAL FIELD

The invention relates generally to scientific data information systems. In particular, the invention relates to a data structure capable of representing various workflows and different types of data in the scientific data information systems.

### BACKGROUND

Modern science-driven organizations, such as biotechnology and pharmaceutical companies, face intense scientific, regulatory, and business challenges. As both regulatory (e.g., Good Practices or GxP) scrutiny and scientific complexity increase, companies are often required to demonstrate in detail that their product (e.g., biologic/pharmaceutical product) is well characterized and that their production process is well controlled. For example, GxP compliance requires a system of administrative and information access controls, in addition to audit trails of user activities and record alterations.

At the heart of the challenge of operating in a regulated (e.g., GxP) environment is a pressure to capture as much orthogonal information as possible during the development process and to leverage the information in manufacturing and quality control. With the continual pressure to capture high-quality data, and do more with it, each functional area within a science-driven organization, and the organization as a whole, could benefit from being able to access and process captured data more efficiently.

### SUMMARY

In one aspect, the invention features a method of processing data comprising defining, by a processor, a task related to performing an operation with data in a data information system, and storing the definition of the task and the data with which the task operates as separate content items in memory. Each content item has a data format that complies with a same unified data structure.

In another aspect, the invention features a data information system comprising memory storing a first content item representing a predefined workflow. The first content item has a data format that complies with a unified data structure. The data information system further comprises a scientific instrument configured to acquire data in accordance with the predefined workflow, and a server in communication with the scientific instrument to obtain the data acquired by the scientific instrument. The server has a processor that executes program code to convert the acquired data into a second content item with a data format that complies with the unified data structure.

In yet another aspect, the invention features a computer program product for processing data. The computer program product comprises a computer-readable storage medium having computer-readable program code embodied therein. The computer-readable program code comprises computer-readable program code configured to define, when executed by a processor, a task related to performing an operation with data in a data information system. The computer-readable program code further comprises computer-readable program code configured to store, when executed by the processor, the definition of the task and the data with which the task operates as separate content items in memory. Each content item has a data format that complies with a same unified data structure.

In still another aspect, the invention features a computer-readable storage medium for storing content items used by an application program being executed on a data information system. The computer-readable storage medium is encoded with a unified data structure to be used to define a data format for each of the content items in the data information system. The unified data structure comprises an instance data element having fields that are specific to a content item, and a catalog data element having a copy of data extracted from the content item-specific fields of the instance data element.

### BRIEF DESCRIPTION OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a schematic view of a scientific data information system.

FIG. 2 is a schematic view of a workstation model including the scientific data information system of FIG. 1.

FIG. 3 is a computer network including the scientific data information system of FIG.

FIG. 4 is a schematic illustration of a content item.

FIG. 5A, FIG. 5B, and FIG. 5C are listings of XML statements corresponding to an example of an instance data element for a signature method content item.

FIG. 6 is a listing of XML statements corresponding to an example of an instance data element for a report method content item.

FIG. 7A and FIG. 7B are listings of XML statements corresponding to an example of an instance data element for a print data content item.

FIG. 8 is a schematic illustration of an example of relationships among content items associated with an analysis.

FIG. 9A and FIG. 9B are listings of XML statements corresponding to an example of an instance data element for a results set content item corresponding to an unprocessed analysis.

FIG. 10A and FIG. 10B are listings of XML statements corresponding to an example of an instance data element for a result content item of the unprocessed analysis.

FIG. 11A and FIG. 11B are listings of XML statements corresponding to an example of an instance data element for a results set content item corresponding to a processed analysis.

FIG. 12A and FIG. 12B are listings of XML statements corresponding to an example of an instance data element for a result content item of the processed analysis.

FIG. 13A and FIG. 13B are listings of XML statements corresponding to an example of a sections data element for a result content item of the processed analysis.

FIG. 14A and FIG. 14B are listings of XML statements corresponding to an example of an instance data element for a report content item.

### DETAILED DESCRIPTION

Scientific data information systems produce and encounter many different types of data and have many different methods of acquiring and manipulating such data. For example, data can be in the form of raw values as measured during an analysis, or they can be in processed form, for example, with information about identified compounds based on retention time, detected peaks, ions and calculated values which can be presented to the user in different ways (e.g. tables, chromatograms, spectra, summary plots). Methods of manipulating the data can include, for example, performing an analysis to acquire the data, generating a report based on the analysis, signing the analysis and/or the report, printing the data, and displaying results.

The scientific data information systems described herein employ a generic data structure to represent each of the different data types and methods, in effect, using a common data format to unify the representation and the management of the data storage units. These data storage units, referred to herein as “content items”, are generally uniform in their defined logical structure, although they may vastly differ in their actual content. A database maintains the content items, to provide a repository of data that many different application programs can access. The uniform (i.e., generic) logical structure of the content items enables application programs to mine the data in the database without having to be tailored specifically for a particular data type. A catalog data element of the generic data structure contains searchable data related to a given content item to improve the relevance of search results. The software and hardware-independent representation of the content items also facilitates data sharing among users of the scientific information systems and across science-based organizations. Moreover, the use of a generic data structure advantageously provides unlimited expandability, allowing the system to accommodate any new data type as it emerges in the future, again, without having to support any data type-specific functionality in the database.

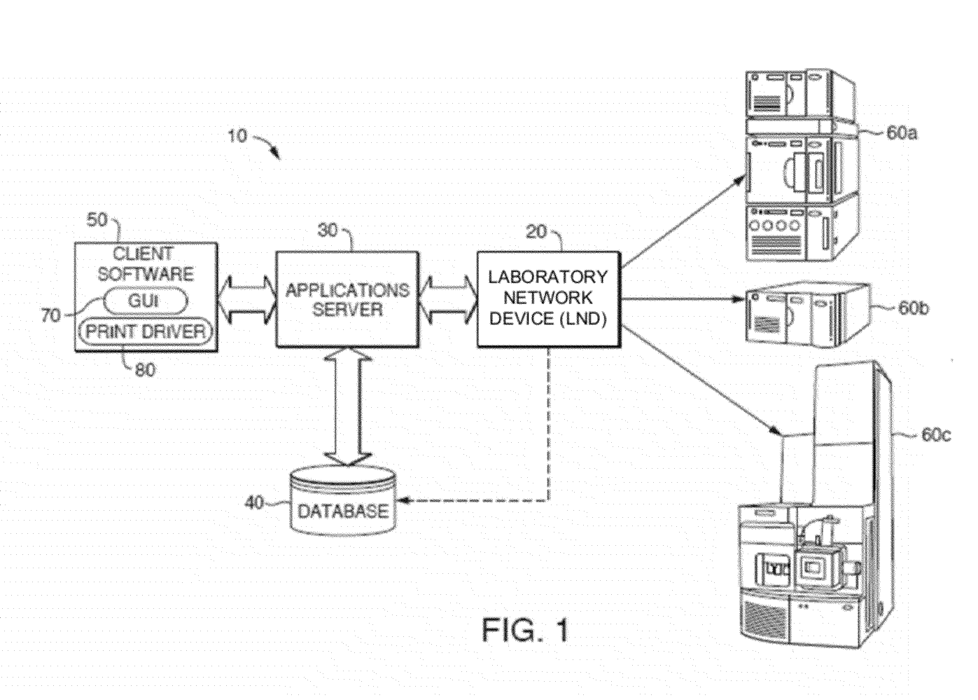

FIG. 1 illustrates an embodiment of a scientific data information system 10 that provides for acquisition of chromatography and mass spectrometry data (within a single software environment), instrument control, data processing and mining, and reporting, with GxP laboratory compatibility that allows for deployment throughout a science-driven organization. The scientific data information system includes a Laboratory Network Device (LND) 20, an application server 30, a database 40, and client software 50. An LND 20 may also be referred to as an instrument systems server or ISS.

The LND 20 is in communication with laboratory instruments 60a-c and includes computer-executable instructions for handling instrument control and data acquisition. The laboratory instruments 60a-c can include, for example, chromatographic instruments 60a, detectors 60b (e.g., UV detectors), and mass spectrometers 60c. Examples of chromatographic instruments include ACQUITY HPLC® H-Class Bio System, available from Waters Corporation of Milford, Mass. Examples of detectors include the ACQUITY HPLC® Tunable UV (TUV) Detector, available from Waters Corporation. Examples of mass spectrometers include the Xevo® G2 T of mass spectrometer, available from Waters Corporation.

Generally, the LND 20 performs two functions: 1) system coordination; and 2) data buffering. The LND 20 can coordinate operation of the instruments based on information (e.g., instrument method and sample set information) received from the application server 30, which allows the LND 20 to set up the instruments and start an acquisition. Instrument methods include instructions for controlling operating parameters of an attached instrument. The LND 20 also provides status information back to the application server 30 during a run.

During data acquisition, the LND 20 receives the data (e.g., chromatographic and/or mass spectrometry (MS) data) acquired by the laboratory instruments 60a-c in a format native to the particular instrument. The LND 20 then translates the acquired data into a unified data format, as described herein, and stores the converted data in a secure file buffer, with a rolling SHA1 checksum, incremented with each data packet, to ensure fidelity and security of the data. A final checksum is calculated upon acquisition completion and the raw data file, in the unified data format, is delivered to the database 40, where the raw data file is stored and locked.

The application server 30 is in communication with the LND 20, the database 40, and the client software 50. The application server 30 is a collection of software that handles the business logic (i.e., the functions that the associated software performs on the data). The application server 30 retrieves data (from the database 40), processes and presents data to a graphical user interface 70, processes input data (e.g., from the graphical user interface 70), and sends method (e.g., instrument method) and sample set information to the LND 20 to set up the instruments and start an acquisition. In addition, the application server 30 and the LND 20 communicate on a host of configuration and setup issues, for example, downloading instrument drivers to the LND 20 and configuring instrument systems. The application server 30 controls this communication with the LND 20.

The application server 30 includes computer-executable instructions for providing administrative and information access controls, in addition to providing audit trails of user activities and record alterations in accordance with GxP compliance requirements. Each unique user has tunable information access (method, data, results, etc.) limitations and activity restrictions dictated by their assigned roles. Users can include administrators, managers, analysts, and principal scientists.

The application server 30 also includes computer-executable instructions for performing data processing, e.g., to reduce the raw data acquired from the laboratory instruments 60a-c into usable reports. Data (e.g., chromatographic data, spectral (MS) data, and bioinformatics) can be processed, by the application server 30, while acquisition is ongoing if processing parameters are specified within a method (e.g., an analysis method). Analysis methods can describe expected system hardware configurations, separation and MS parameters, spectral processing and bioinformatics analysis tasks, and links to automated reporting templates, which can be used to automate production of standardized reports. Following data collection, a copy of the corresponding analysis method can be stored as part of each results set. The application server 30 also relays information, e.g., method and sample set information, to the LND 20, which then controls the instruments 60a-c according to the information provided.

The application server 30 can also include a search engine, which can allow users to search the contents of the database 40. The database 40 is, in one embodiment, a relational database. Relational databases enable real-time acquisition, processing, and management of large volumes of data from multiple sources. This can allow for simultaneous processing, review, and acquisition of data and parallel data acquisition from multiple instrument systems. Suitable relational databases include the Oracle® 11gR2 relational database, available from Oracle Corporation of Redwood Shores, Calif. Information stored in the database 40 can include many different data types (e.g., analyses, raw data, reports, historical data, methods, etc.), each of which may be stored as a “content item” having a data format that complies with unified data structure. The use of a unified data structure can help to enable all laboratory functions to work with a common backbone of analytical information. This data standardization can also help to increase the exchange of information within an organization (e.g., between product development and product manufacturing), and, in some cases, even globally (e.g., with third-party partners).

The client software 50 includes computer-executable instructions (e.g., a Windows Presentation Foundation (or WPF) piece of code) for providing the graphical user interface 70, which displays data and allows the user to interact with the data (via the application server 30). Users can use the graphical user interface to select/define methods (e.g., instrument methods, analysis methods, capture methods, signature methods), to process data, and electronically review and sign reports. When the user decides to process data, instructions are sent the application server 30, where the processing takes place.

The client software 50 also includes a print driver 80 for performing print capture. The software generates a print file and moves the print file through the application server 30 for storage within the database 40. The print capture feature can be used for bringing in auxiliary information into the system.

The client software 50 can also include a browser that can communicate with the search engine of the application server 30 to allow the user to perform text searches for data within the database 40.

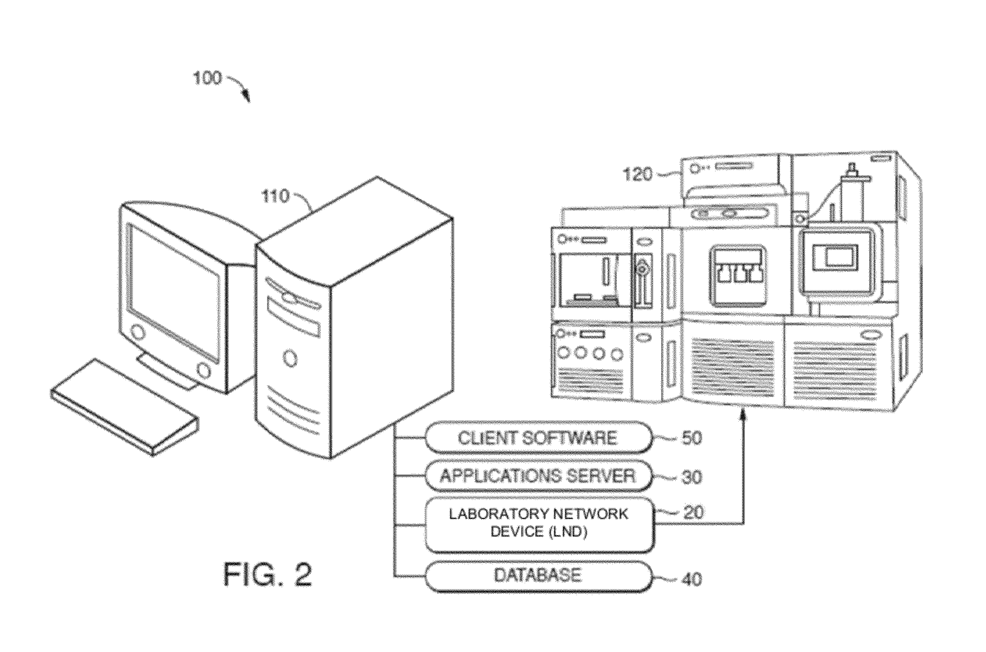

The scientific data information system 10 can be implemented in a variety of configurations, from an individual workstation model, to a network model, such as a laboratory-based workgroup or networked enterprise environment. In a workstation model, one computer handles both the low-level (e.g., database management and instrument control) and high level (e.g., data processing and user interface) functions. For example, FIG. 2 illustrates a workstation 100 in which the client software 50, the application server 30, the LND 20, and the database 40 all reside on a single computer 110. A suitable computer 110 for the workstation 100 is a Lenovo D20 Workstation configured with dual Xeon E5504 2.0 GHz processors, 8 GB RAM, Nvidia Quadro FX 18000 graphics card under the Windows 7 64-bit operating system. The workstation 100 can also include a key board and a pointing device (e.g., a mouse or a trackball) for receiving user input, and a display device for displaying the graphical user interface 70. The workstation 100 can be physically located next to a laboratory instrument 120, such as a liquid chromatography (LC)/mass spectrometry (MS) system.

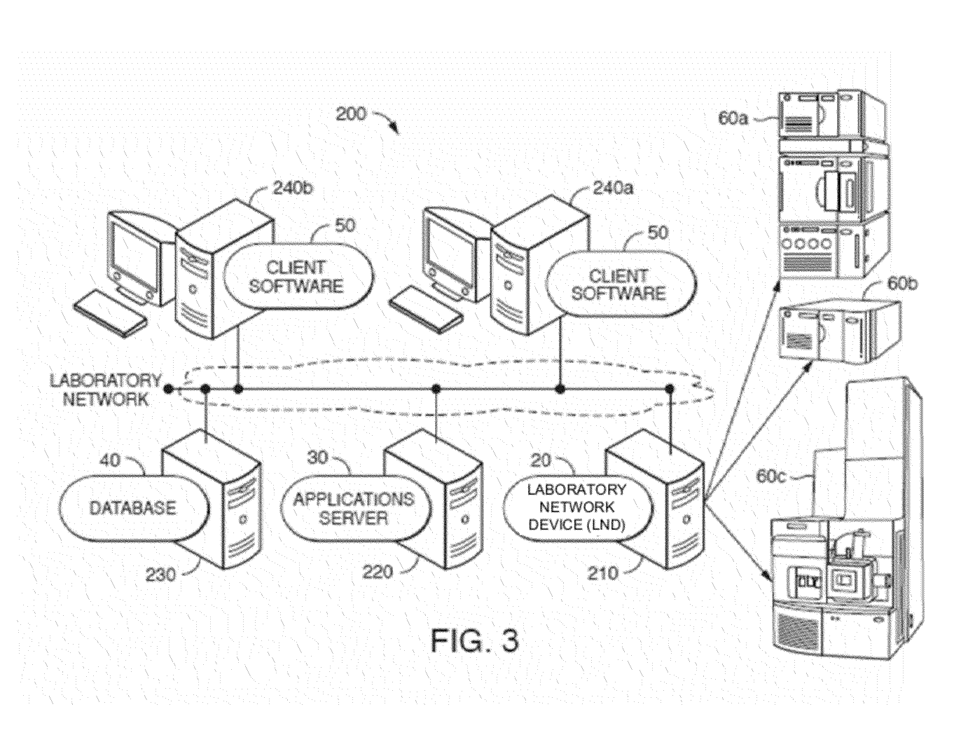

In a network model, the user interface, data processing, database management and instrument control functions can be split across separate computers which may be connected over a computer network, e.g., such as a local area network (LAN), wide area network (WAN), the Internet, or a combination thereof. For example, FIG. 3 illustrates a network 200 that includes an information system computer 210, an application server computer 220, a database management computer 230 and one or more client PC's 240a, 240b on which the LND 20, the application server 30, the database 40, and the client software 50 reside, respectively. In some cases, such as in a laboratory-based workgroup, the application server and the database may reside on a common computer.

Each of the network computers can include a processor for processing instructions (e.g., stored in memory or on a storage device) for execution within the corresponding computer; a memory (e.g., volatile memory, non-volatile memory, a magnetic disk, an optical disk, etc.) for storing information within the corresponding computer; and a storage device (e.g., a floppy disk device, a hard disk device, an optical disk device, or a tape device, a flash memory, etc.) for providing mass storage for the corresponding computer.

### Content Items

As previously described, data and methods are stored within the database 40 in a data format consistent with a unified data structure. The data structure is generic in that it does not contain information about the application-specific use of the maintained data; accordingly, many different types of data (e.g., chromatography, detector, mass spectrometer, raw and processed) and methods (e.g., analyses, reports, print, display, instrument, qualification, etc.) can be stored and managed in a generic way. This approach enables a potentially unlimited number of data types and method types to be supported without the need for type specific functionality. Each content item in the scientific data information system 10 follows this generic data structure.

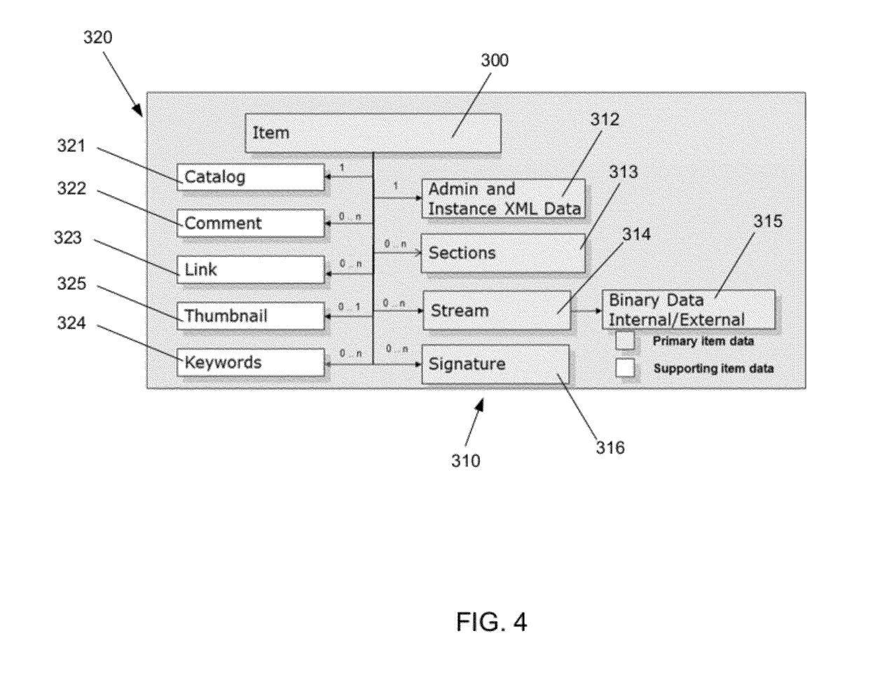

FIG. 4 illustrates a general overview of an embodiment of a schema for a content item 300, which can be considered to include primary data elements 310 and supporting data elements 320. The primary data elements 310 include an admin and instance data element (or simply instance data element) 312, zero, one, or more sections elements 313, zero, one, or more stream elements 314, a stream data element 315 for each defined stream data element 314, and zero, one, or more signature data elements 316. In one embodiment, each content item 300 is constructed and managed as an XML document. Text and XML data of the content item can be stored as Unicode data.

The instance data element 312 contains basic fields or attributes that are available for all items. “Fields” and “attributes” refer to metadata used to describe or provide information about the corresponding content item. The fields can include standard fields for every content item, which cannot be changed by the user, and custom fields, which are defined by and can be changed by the user. The instance data element 312 also contains data (e.g., in XML form structured according to a specific XML schema) specific to the item type of content item.

The sections element 313 can contain the detailed item specific data (e.g., in XML form structured according to a specific XML schema). In general, the sections element 313 is an extension of the instance data element 312 used to keep the instance data element from becoming overly large by providing an offload for certain types of data, for example, component tables. Thus the sections element 313 provides a mechanism by which such offloaded data can be managed separately from the information contained within the instance data element 312. Accordingly, such information held by the instance data element can be concentrated primarily on defining the structure of the item type of a given content item and on determining how a managing application program understands the content item, whereas the sections element 313 can be, in effect, a repository for data produced, for example, by certain processing.

The stream data element 314 can contain maintenance information about any stored streams in the content item (e.g., system internal data such as a StreamID, a message digest, size, etc.). The stream element 315 contains the content (file) of the dependent streams, which, for example, can include raw data acquired from the laboratory instruments, processed data, and print data. The amount of data incorporated into the content item by the stream data element 314 can be on the scale of gigabytes or more for each stream 315. The signature data element 316 can contain one or more electronic/digital signatures applied to the content item.

The supporting data elements 320 include a catalog 321 and optional comments 322, links 323, keywords 324, and thumbnails 325. The catalog 321 includes a table that holds redundant searchable data extracted from the instance data element 312. The particular fields of the instance data element 312 from which to extract data can be predefined for a given type of content item, or user configured. Advantageously, the metadata stored in the catalog 321 can improve the speed at which searches of the database 40 complete.

The comments 322 can contain file attachments. The links 323 can include hyperlinks to external data sources and/or to other content items. Through the link element 323, an end-user can define relationships between content items. The keywords 324 can include user-supplied keywords to enhance searches for the content item. The thumbnails 325 can contain renditions of the content in the content item, or, for example, of a default data format specific image to be used in search result lists, to give the user a first visual impression of the content associated with the content item.

### EXAMPLES

Each content item 300 is of an item type. The item type of a content item determines which data elements of the content item contain information, the fields or attributes specific to the instance data element 312 of that content item, and the particular fields or attributes of the instance data element 312 from which data are extracted to populate the catalog 321 of that content item.

One category of types of content items is referred to as the Method category. In general, a method operates to perform a task or implement a workflow in the data information system. Examples of method content items include signature methods, print methods, reporting methods, qualification methods, and analysis methods. A signature method content item defines a workflow by which one or more electronic or digital signatures are applied to a content item. In general, reporting method content items, also referred to as report templates, define the characteristics and content to be provided in a report. Print method content items define a manner in which to print captured data. An analysis method content item defines an automated workflow governing the performance of an analysis. A given analysis method content item can link to one or more other method content items, for example, a signature method or a reporting method. A qualification method contains settings to perform an automated qualification workflow for qualifying the software and connected instrument systems (e.g., as generally required by regulated industries).

Each method content item has an instance data element 312, with a generic portion common to all instance data elements of a method content item, and a specific portion, which is specific to the content item.

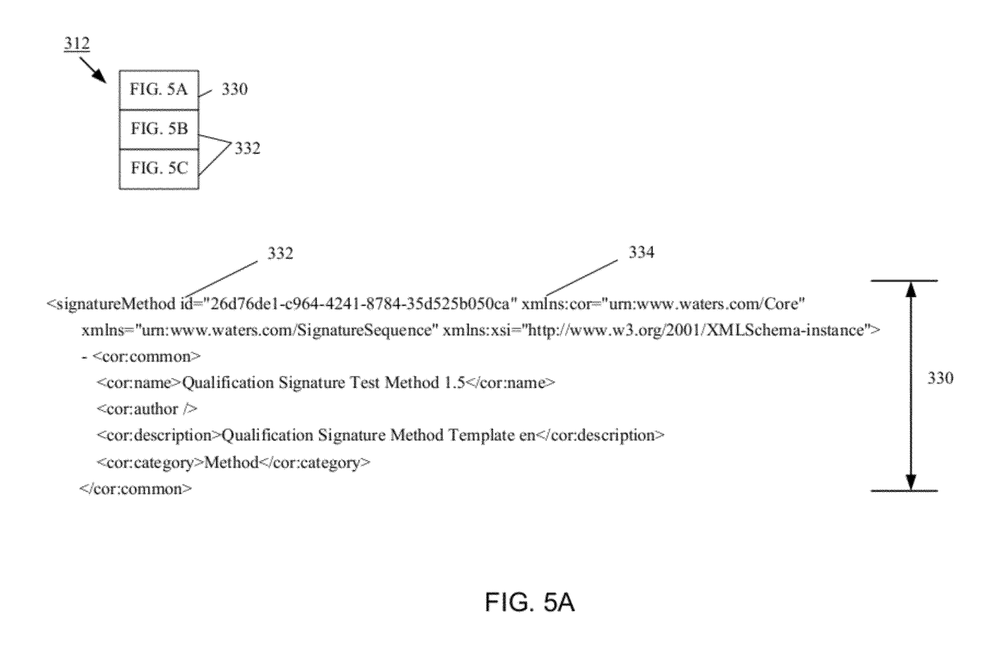

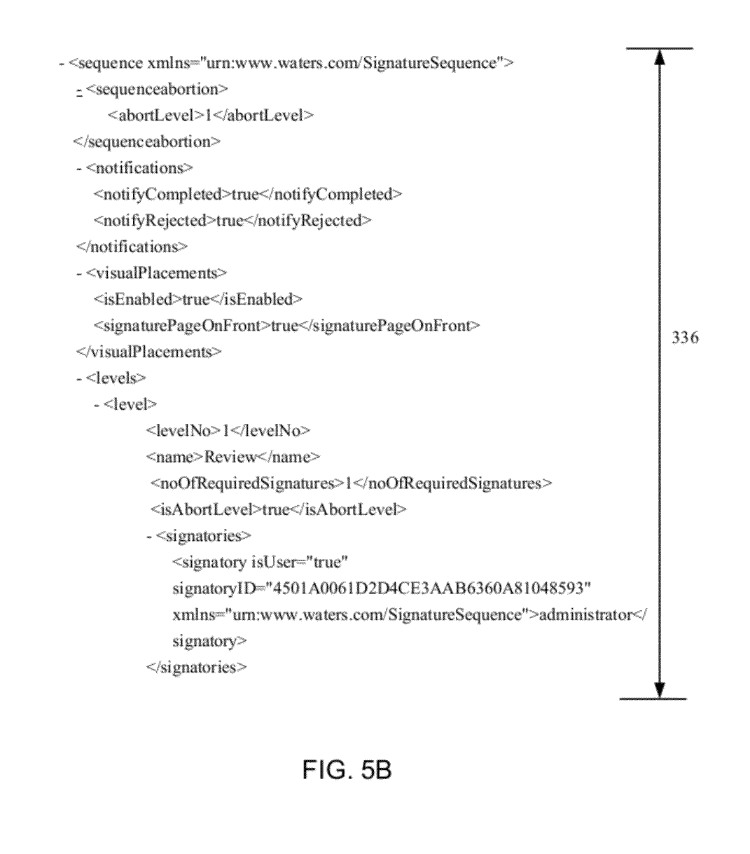

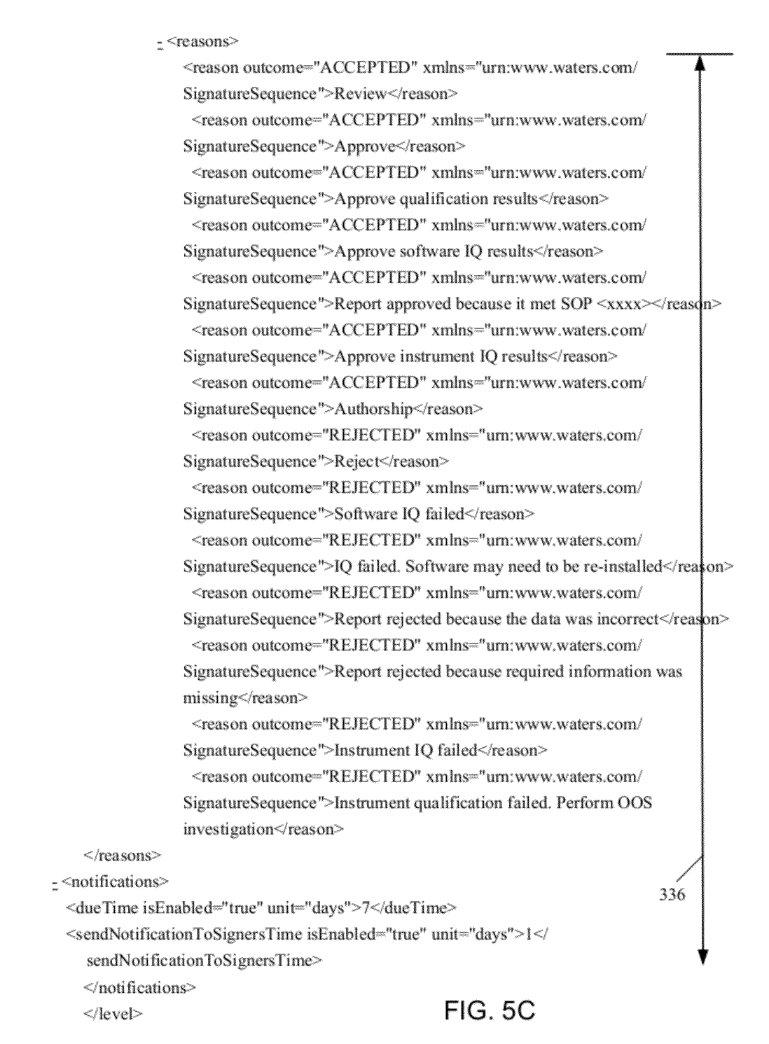

The instance data element 312 of a signature method content item can have an XML structure as shown, for example, in FIG. 5A, FIG. 5B, and FIG. 5C. FIG. 5A shows a generic portion 330 of the instance data element 312 between the <cor:common> tags. The content item-specific portion of the instance data element 312 includes a root element 332 (FIG. 5A), the namespace 334 (FIG. 5A), and special settings 336 (FIG. 5B and FIG. 5C). Only an excerpt of the item-specific portion of the instance data element 312 is shown.

A signature method content item generally does not have information corresponding to a sections data element 313, a streams data element 315, a signature data element 316, or a catalog 321 defined specifically for this type of method content item (although other embodiments of a signature method content item can include any one or combination of these elements). The catalog 321 of a signature method content item does include data automatically extracted from the generic portion 330 of the instance data element 312. Such metadata extraction is done by default for each item type described herein. A signature method content item can also have supporting data elements, such as comments 322 and keywords 324, depending on whether a user defines such data elements for a given signature method content item through the graphical user interface 70.

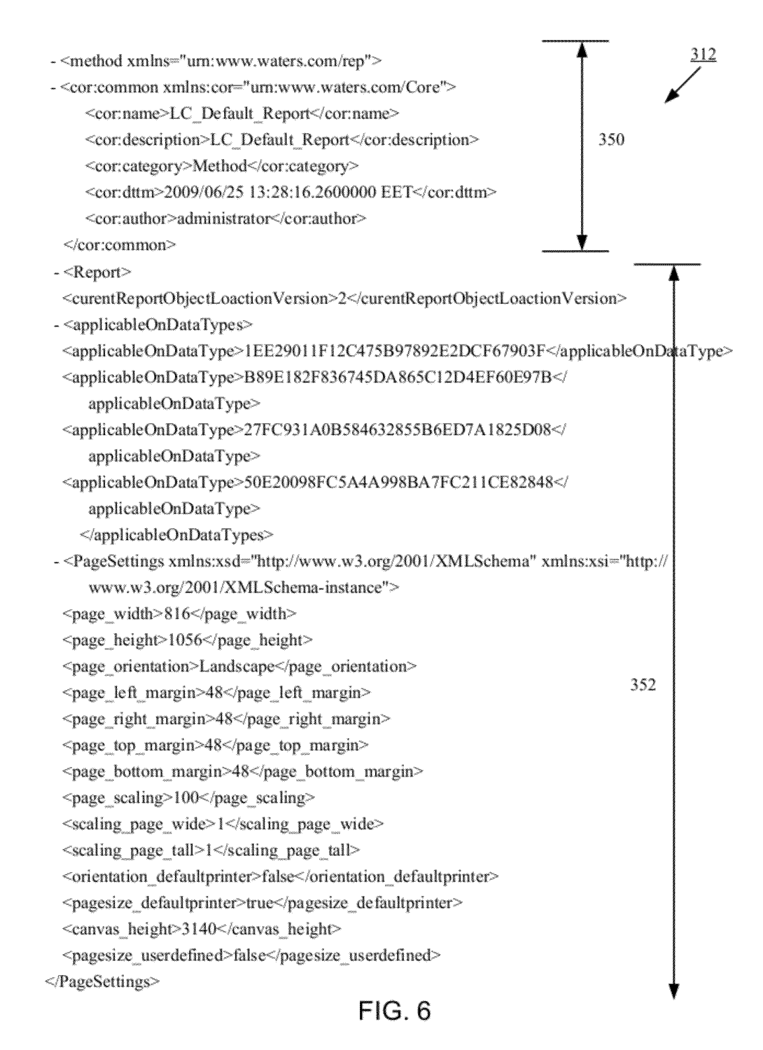

FIG. 6 shows an embodiment of the instance data element 312 of a reporting method content item with a generic portion 350, which is common to all reporting method content items, and a specific portion 352, which is specific to a given reporting method content item. A reporting method content item generally does not have a sections element 313, a streams element 315, or a signature element 316. In addition to the default information acquired from the generic portion 350 of the instance data element 312, a catalog data element 321 has a table with additional fields that correspond to certain fields (or attributes) of the instance data element 312 from which metadata are extracted. In one example embodiment, the additional fields are called, for example, 1) applicableOnDataType; 2) repObjectClassName; and 3) reportCulture. The catalog data element 321 includes a table with columns corresponding to these additional attributes. The metadata extracted from the instance data element 312 are placed into these columns. In general, whenever a search query seeks to extract data from the catalog element 321 of a content item, the search query takes into account the item type of the content item and the definition of its catalog element 321. For a content item of the reporting method type, for example, the search query is configured to extract data from three columns corresponding to these three additional fields.

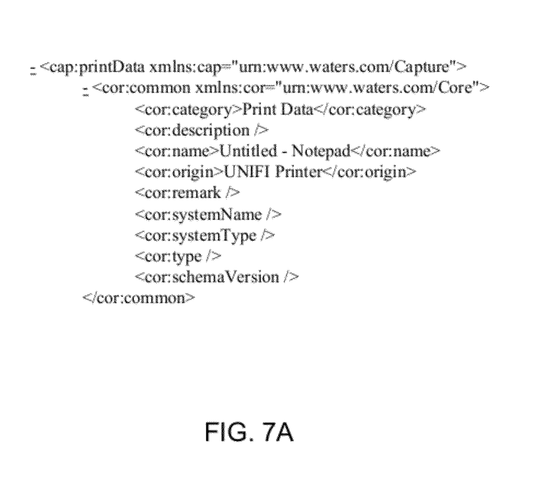

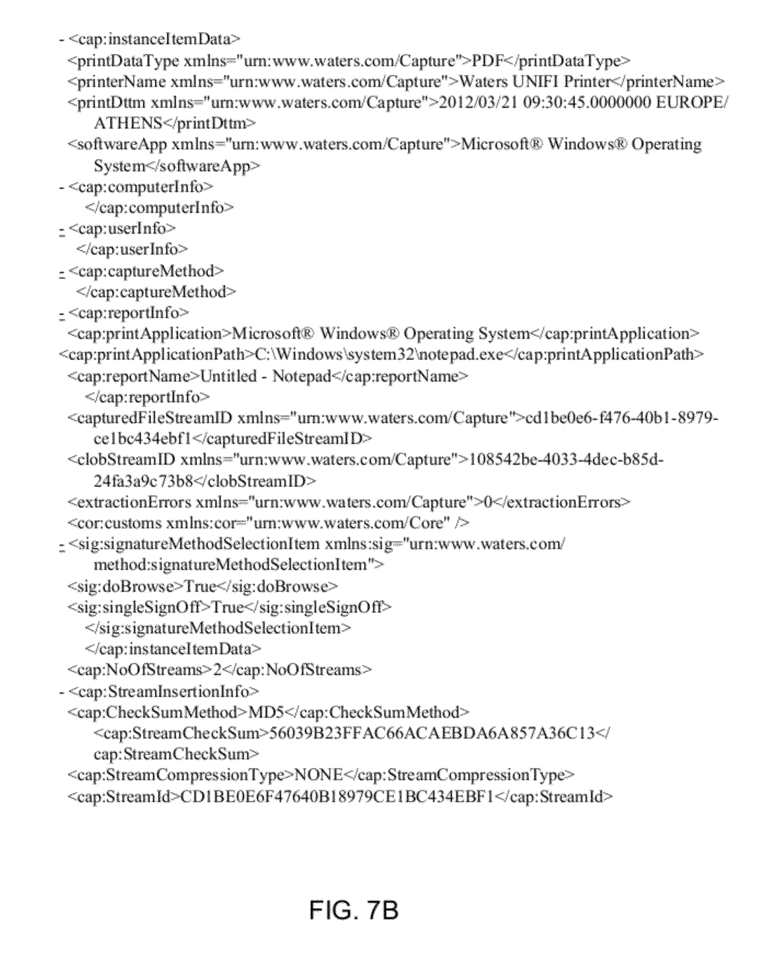

FIG. 7A and FIG. 7B show an embodiment of an excerpt of the instance data element 312 of a print data content item containing data captured by a capture printer. FIG. 7A shows the generic information common to print data content items. FIG. 7B shows information of the instance data element 312 specific to a given print data content item. Print data content items have at least one stream data element 314 with a corresponding stream 315. This stream 315 is the binary data stream of the captured print data. Print data content items can have a defined signature element 316, but do not have a defined sections element 313.

The catalog data element 321 includes metadata extracted from the instance data element 312 and inserted into predefined columns of the catalog element 321. Table 1 shows one example of the mapping of metadata extracted from attributes of the instance data element to columns of the catalog 321. The Vstring column of TABLE 1 contains examples of specific metadata extracted from the instance data element 312 of the example print data content item shown in FIG. 7A and FIG. 7B. Columns without any data correspond to empty fields within the instance data element 312.

TABLE 1

| COLUMN | ATTRIBUTENAME | VSTRING |
|---|---|---|
| 1 | printDataType | PDF |
| 2 | printerName | Waters UNIFI Printer |
| 3 | printDttm | 2012/03/20 11:09:42.000 . . . |
| 4 | nameApp | (null) |
| 5 | userApp | (null) |
| 6 | technique | (null) |
| 7 | projectApp | (null) |
| 8 | softwareApp | Microsoft ® Windows ® Op . . . |
| 9 | sampleID | (null) |
| 10 | sampleType | (null) |
| 11 | sampleList | (null) |
| 12 | sourcePath | (null) |
| 13 | sourceMachine | (null) |
| 14 | acqdateApp | (null) |
| 15 | loginName | romlukm |
| 16 | domainName | CORP |
| 17 | machineName | PC185 |
| 18 | operating System | Windows |
| 19 | userID | 4501a006-1d2d-4ce3-aab . . . |
| 20 | cmName | Default Batch Mode |
| 21 | emName | (null) |
| 23 | printApplication | Microsoft ® Windows ® Op . . . |
| 24 | reportName | Untitled - Notepad |
| 25 | dataSize | (null) |
| 26 | smName | (null) |

FIG. 8 shows an example of an analysis 370 based on liquid chromatography (LC) data. In general, analyses have complex structures comprised of multiple content items connected in various ways by relations such as “PART OF”, “USED BY”, and “BASED ON”. This analysis 370 includes multiple content items, including a “My Analysis” content item 300-1, which is a results set having four children content items 300-2, 300-3, 300-4, and 300-5. Each child content item is labeled “Injection Result” and is connected to the “My Analysis” content item 300-1 by a “PART OF” relation. Each of the four children content Items 300-2, 300-3, 300-4, and 300-5 is connected to a respective Injection Data content item 300-7, 300-8, 300-9, and 300-10 by a “BASED ON” relation 374. Each Injection Data content item contains raw data (in this example, liquid chromatography data), and each Injection Result content item contains processed data based on the raw data of the respective Injection Data content item to which that Injection Result content item is connected. In addition, an Analysis Method content item 300-6 is connected to the “My Analysis” content item 300-1 by a “PART OF” relation 372. This Analysis Method content item 300-6 is based on another Analysis Method content item 300-11. The My Analysis content item 300-1 and its “PART OF” children content items 300-2, 300-3, 300-4, 300-5, and 300-6 collectively encompass the analysis 370.

Other content items can be connected to the My Analysis content item 300-1. For example, a report content item 300-12 is connected to the My Analysis content item 300-1 by a “USED BY” relation 376, indicating that the report defined by the report content item 300-11 uses the results set contained within the My Analysis content item 300-1.

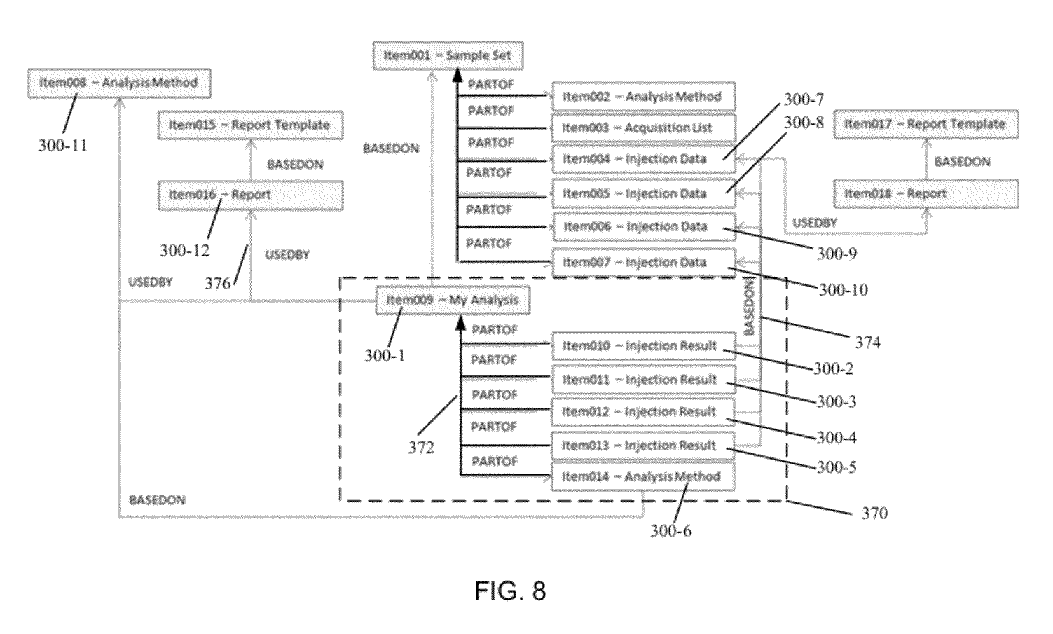

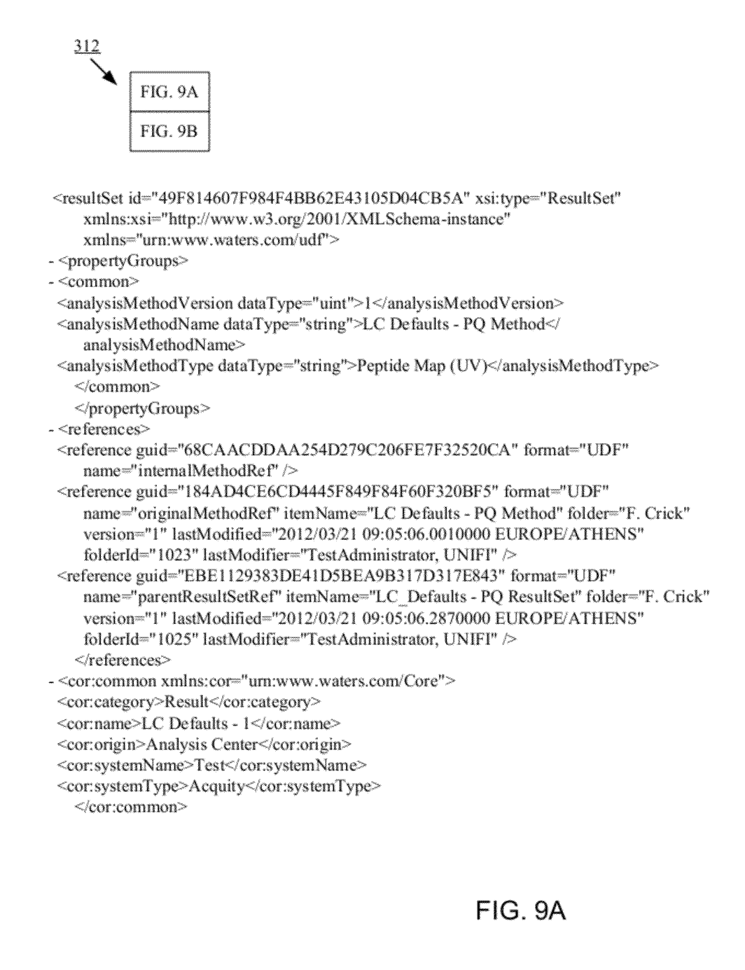

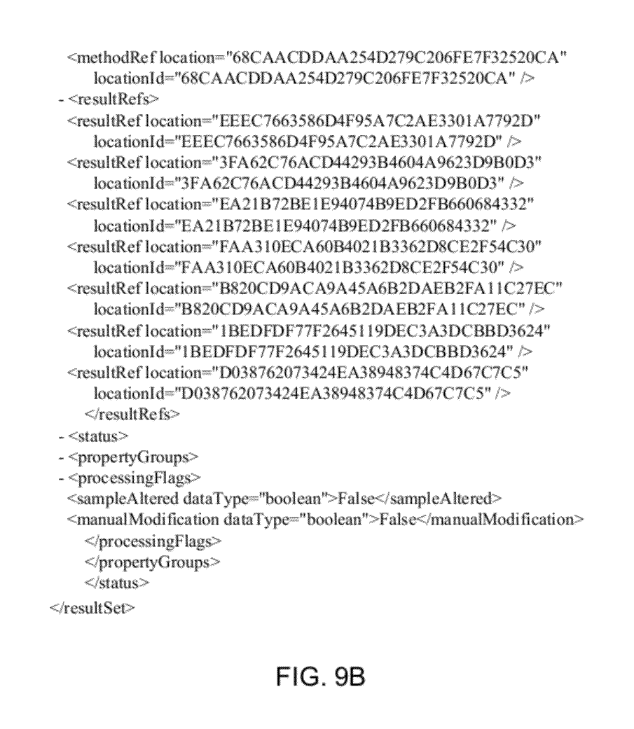

The data structure of a results set (the My Analysis content item 300-1 being an example) includes an instance data element 312 with fields specific to this result set, as shown in FIG. 9A and FIG. 9B. In this example, the results set content item 300-1 corresponds to an unprocessed analysis. An application program interacting with this results set content item 300-1 is configured to handle the specific XML structure of the instance data element 312 in order to display the details of the unprocessed analysis.

The results set content item 300-1 also has a catalog 321 element with predetermined attributes that are extracted from the instance data element 312 (in addition to the <cor:common> information in the generic portion). TABLE 2 provides an example of the attribute values (vstring) extracted from the instance data element 312 and copied into the table of the catalog 321.

TABLE 2

| COLUMN | ATTRIBUTENAME | VSTRING |
|---|---|---|
| 0 | commonname | LC Defaults −1 |
| 0 | commonorigin | Analysis Center |
| 0 | commondescription | (null) |
| 0 | commoncategory | Result |
| 0 | commonremark | (null) |
| 0 | commonsystemname | Test |
| 0 | commonsystemtype | Acquity |
| 0 | commonparentname | LC Defaults −1 |
| 3 | analysisMethodType | Peptide Map (UV) |
| 2 | analysisMethodVersoin | 1 |
| 24 | manualModification | False |
| 1 | analysisMethodName | LC Defauls - PQ Method |
| 25 | sampleAltered | False |

Section 303, streams 315, and signature elements 316 are unused in the My Analysis content item 300-1.

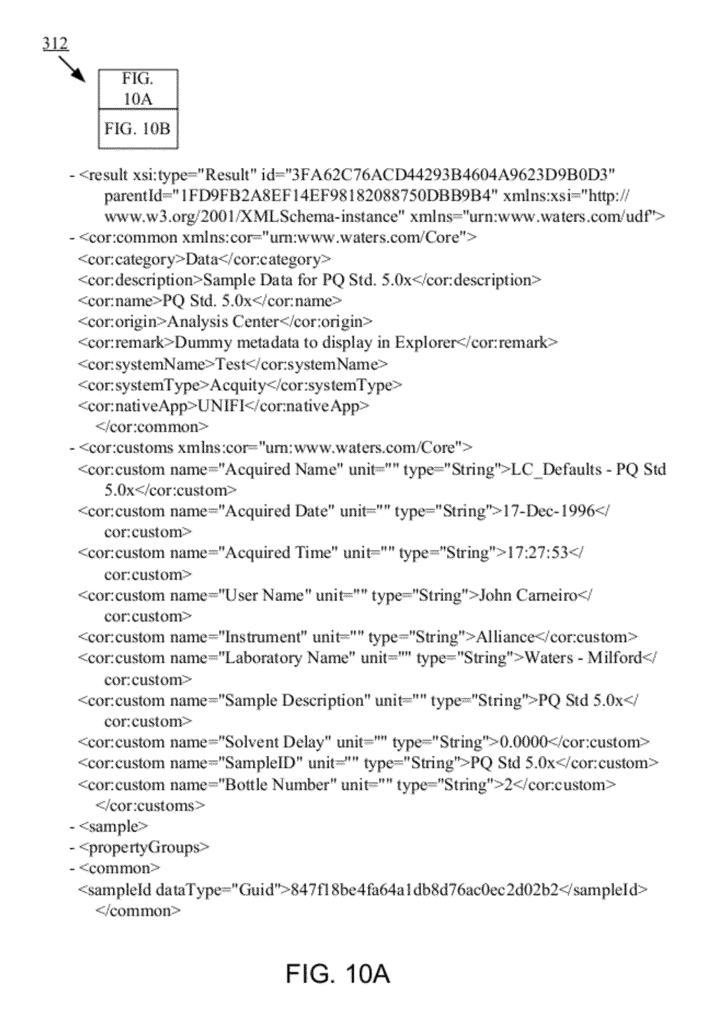

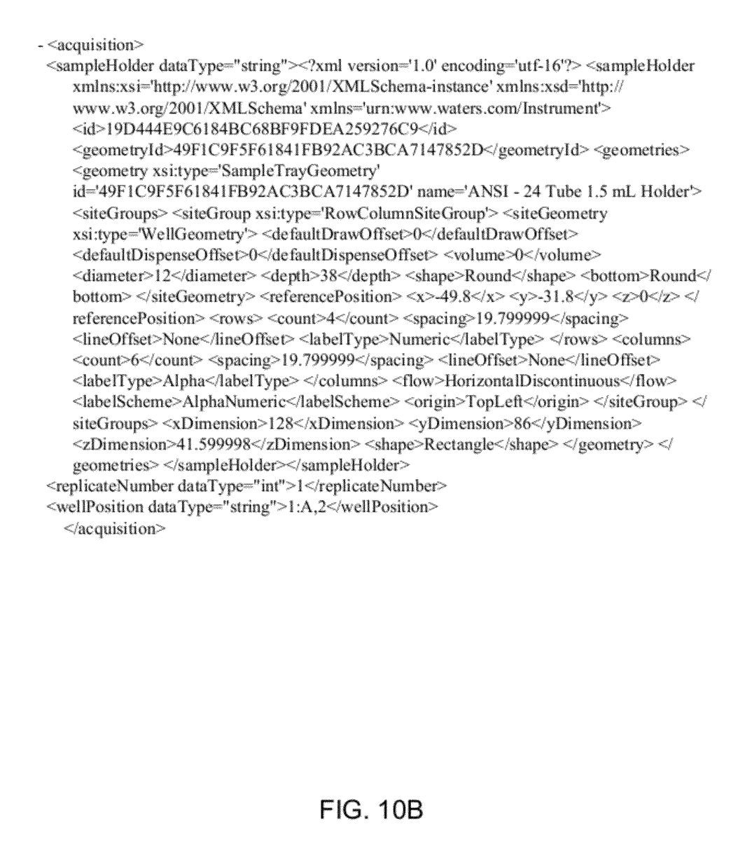

As previously described in FIG. 8, the My Analysis content item 300-1 has multiple “PART OF” children content items 300-2, 300-3, 300-4, and 300-5, referred to as Injection Results (or simply result) content items. A result content item (e.g., Injection Result content items 300-2) is of a different item type from a result set content item (e.g., My Analysis content item 300-1). Each of these Injection Result content items can have instance data element 312 with fields specific to that content item, as shown in FIG. 10A and FIG. 10B, a stream 316 of data corresponding to the injection results, and a catalog 321 with predetermined attributes that are extracted from the instance data element 312 (in addition to the <cor:common> information). Table 3 shows an example of the attribute values (vstring) extracted from the instance data element 312 of the Injection Result content item and copied into the table of the catalog 321 of that Injection Result content item.

TABLE 3

| COLUMN | ATTRIBUTENAME | VSTRING |
|---|---|---|
| 2 | sampleType | Standard |
| 3 | sampleLevel | Level2 |
| 4 | sampleWeight | 1 |
| 5 | dilution | 1 |
| 6 | injectionVolume | 20 |
| 7 | bracketGroup | Group 1 |
| 14 | replicateNumber | 1 |
| 15 | wellPosition | 1:A,2 |
| 16 | sampleId | 847f18be4fa64a1db8d76 . . . |

Section 303 and signature elements 316 are unused in the Injection Result content items 300-2, 300-3, 300-4, and 300-5.

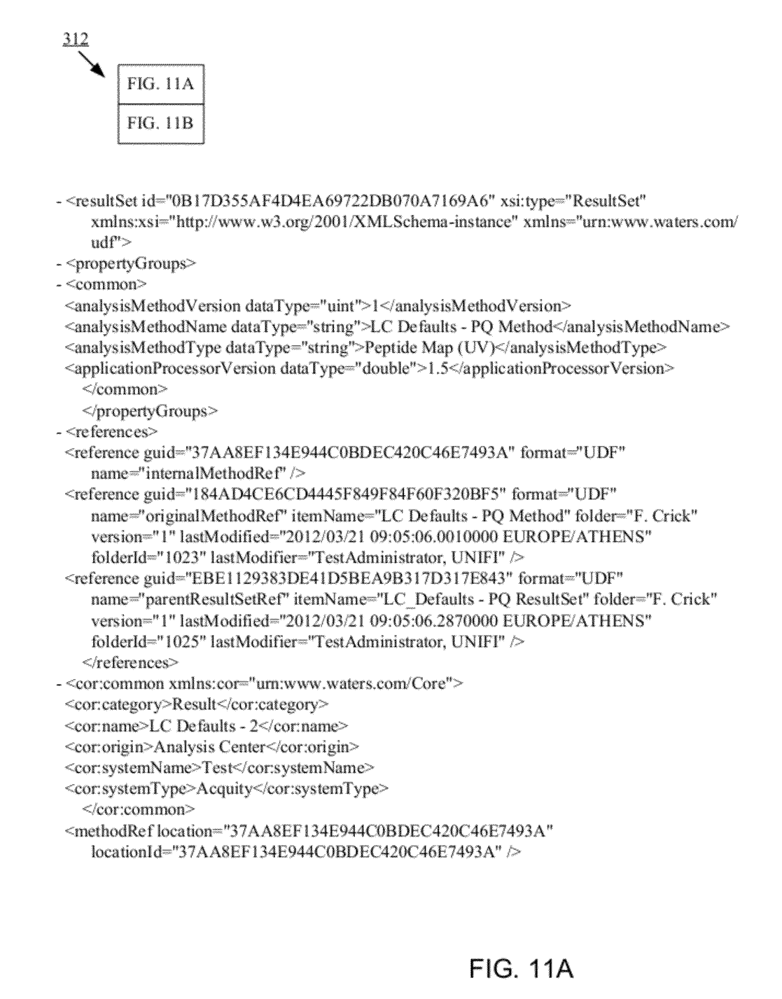

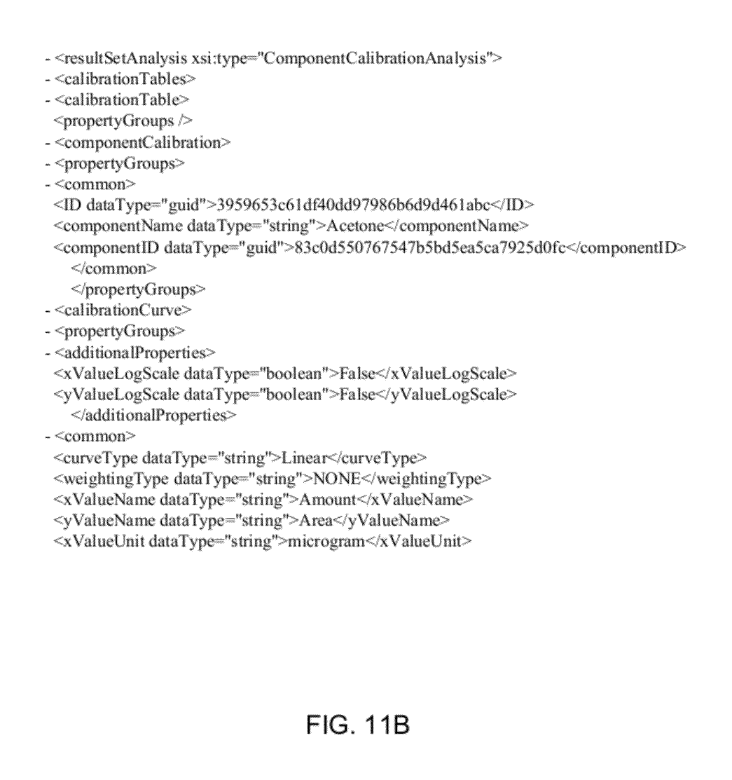

Processed analyses use content items of the same item types as unprocessed analyses. One difference is that the instance data element 312 of a result set content item of a processed analysis (as shown, for example, in FIG. 11A and FIG. 11B) has more specific information than the instance data element of the result set content item of an unprocessed analysis.

The catalog 321 for a result set content item of a processed analysis is defined the same as for the result set content item of a unprocessed analysis; results sets for processed and unprocessed analyses are of the same item type; and the item type determines which attributes are to be extracted from the instance data element and copied to the catalog element. Table 4 shows an example of the attribute values (vstring) extracted from the instance data element 312 of the results set content item of a processed analysis and copied into the catalog 321 of that content item. Some fields (columns) may be missing from the catalog 321 when the instance data element 312 has no value for the corresponding attributes.

TABLE 4

| COLUMN | ATTRIBUTENAME | VSTRING |
|---|---|---|
| 1 | analysisMethodName | LC Defaults - PQ Method |
| 2 | analysisMethodVersion | 1 |
| 3 | analysisMethodType | Peptide Map (UV) |
| 24 | manualModification | False |

Section 303, stream 315, and signature data elements 316 are unused in a results set content item for a processed analysis.

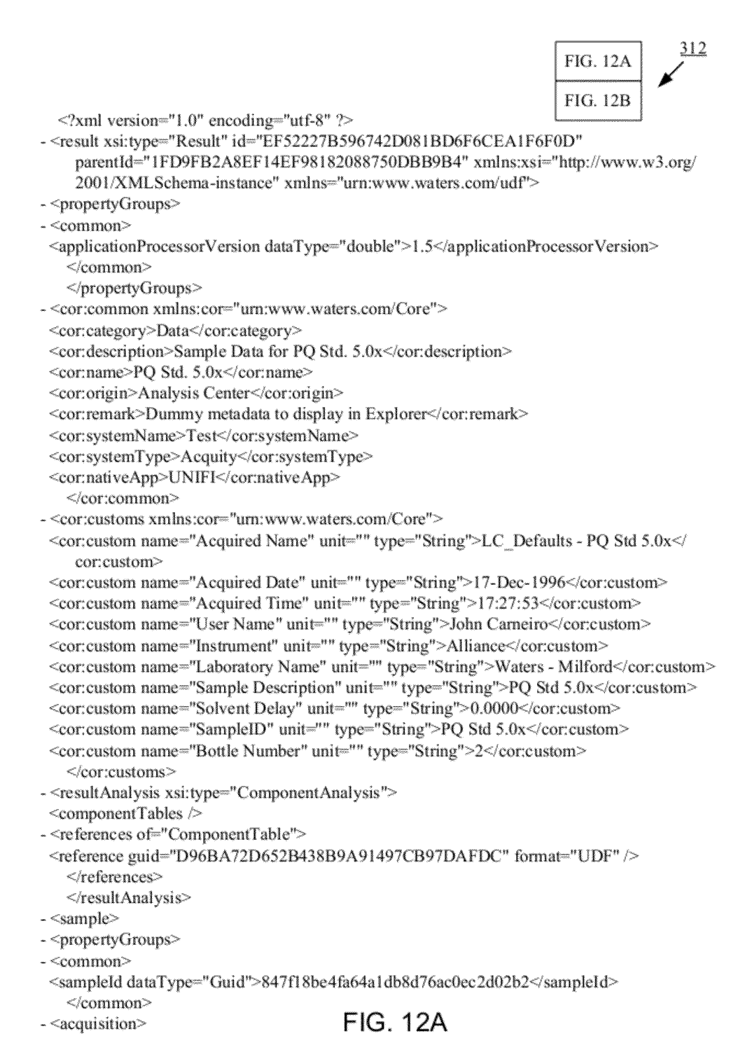

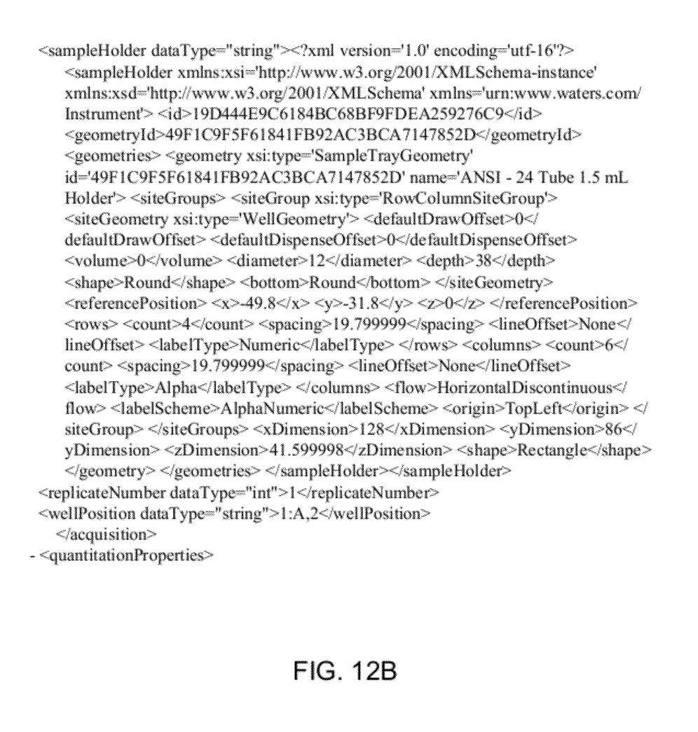

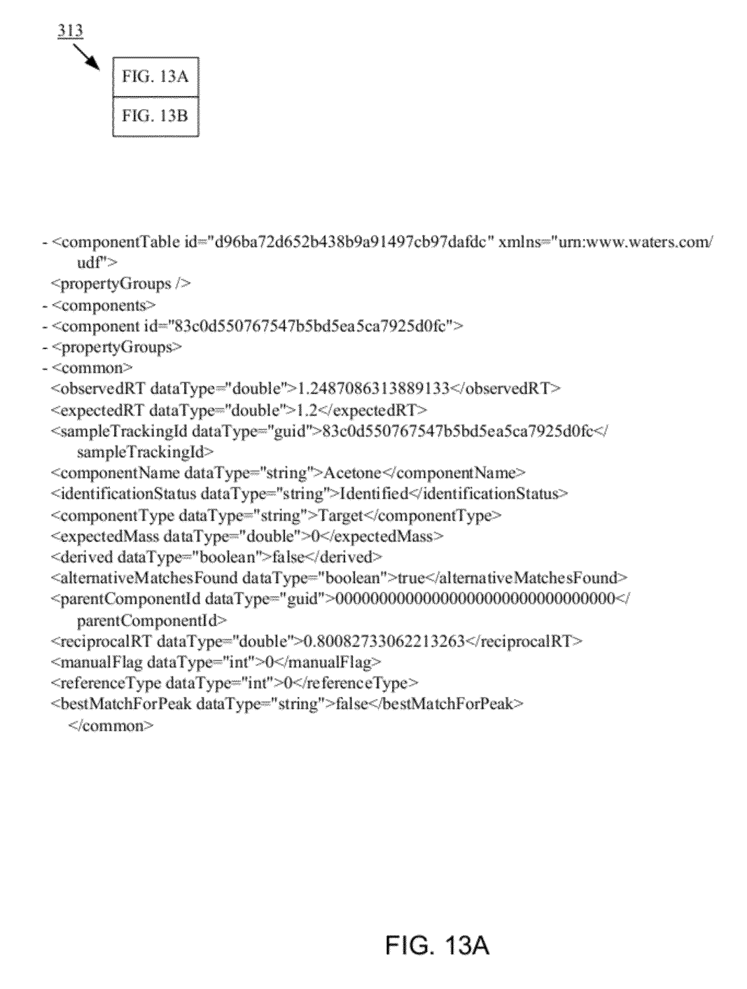

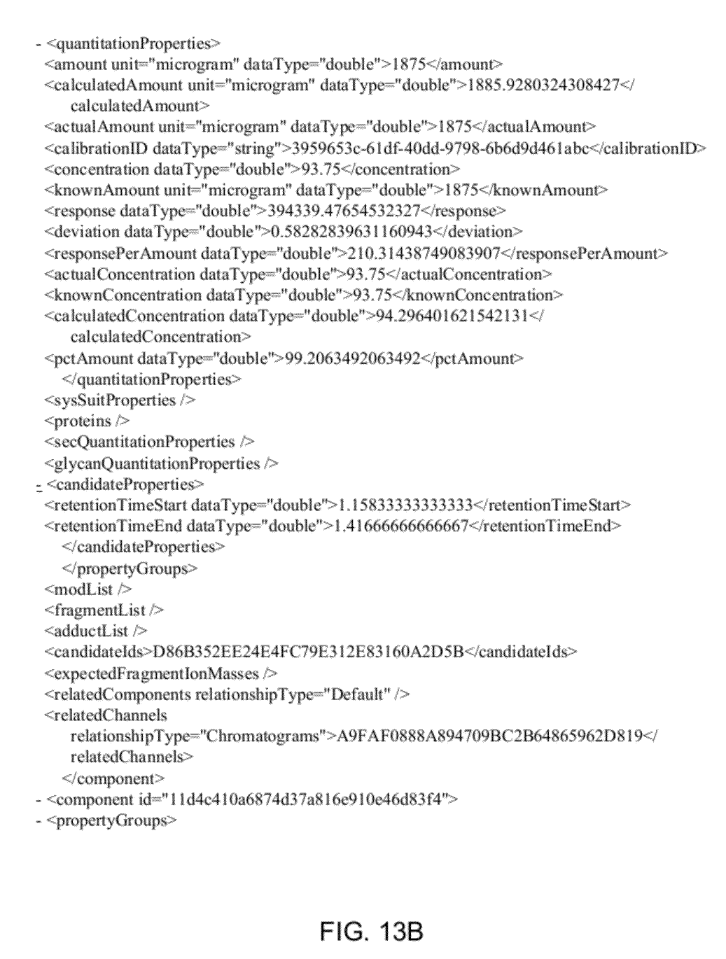

Similarly, the instance data element 312 of a result content item of a processed analysis (as shown, for example, in FIG. 12A and FIG. 12B) has more information than the instance data element 312 of a result content item of an unprocessed analysis. As illustrative examples of result content items, each of the Injection Result content items 300-2, 300-3, 300-4, and 300-5 has an instance data element 312 that is enhanced with processing information. Each of the Injection Result content items 300-2, 300-3, 300-4, and 300-5 also has a defined sections data element 313. After processing, each Injection Result content item has one component table in the sections data element 313 to record the identified components and their related properties (as shown, for example, in FIGS. 13A and 13B). In addition, in this example, each Injection Result content item 300-2, 300-3, 300-4, and 300-5 has a stream data element 314 containing binary information 315 related to the processed data. In some instances, an Injection Result content item may not have a stream.

The catalog 321 for a result content item of a processed analysis is defined the same as for the result content items of an unprocessed analysis (result content items of processed and unprocessed analyses being of the same item type, which defines those attributes to be extracted from the instance data element 312 and copied into the catalog). Table 5 shows an example of the attribute values (vstring) extracted from the instance data element 312 of a result content item of a processed analysis and copied into the catalog 321 of that content item.

TABLE 5

| COLUMN | ATTRIBUTENAME | VSTRING |
|---|---|---|
| 2 | sampleType | Standard |
| 3 | sampleLevel | Level2 |
| 4 | sampleWeight | 1 |
| 5 | dilution | 1 |
| 6 | injectionVolume | 20 |
| 7 | bracketGroup | Group 1 |
| 14 | replicateNumber | 1 |
| 15 | wellPosition | 1:A,2 |
| 16 | sampleId | 847f18be4fa64a1db8d76 . . . |
| 17 | processingOptions | QuantitationSTD |
| 23 | limitState | NO_CHECKS_PERFORMED |
| 24 | manualModification | False |

Result content items of processed analyses do not typically use the signature data element 316.

Another item type for content items is reports. Reports can be generated from an analysis or from any other content item. Each report is based on a report template, which defines the graphical “look and feel” of the report and the fields to be displayed for a given content item. The item type of the content item determines the fields selected for display by a report template. For example, if a report is to be generated from a results set content item corresponding to an analysis, the report template is not going to display a printerName field, because this field is specific to the print data content item and not associated with a results set.

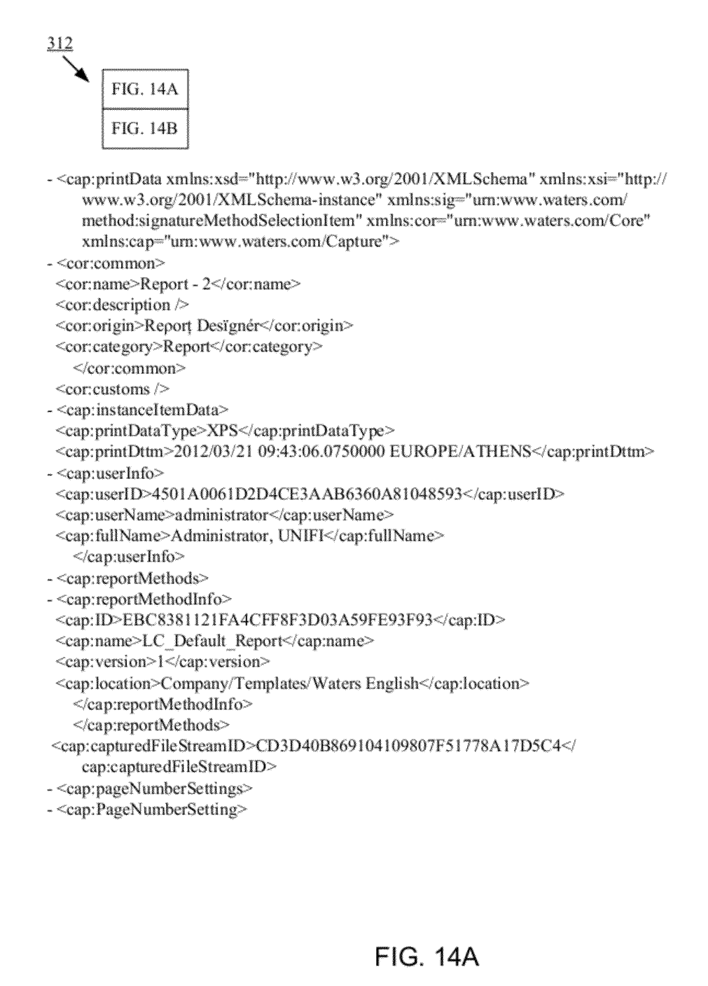

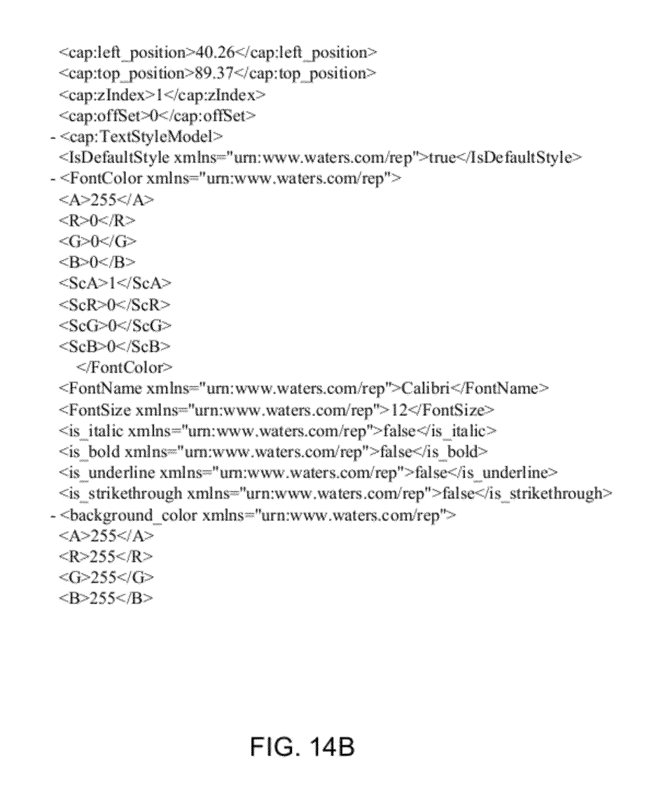

A report content item, which has a same item type as a print data content item, has a specific instance data element 312 as shown, for example, in FIG. 14A and FIG. 14B. A report content item further comprises a defined stream data element 314 and binary stream 315 (which can be the report, for example, in the form of a .xps file), and, optionally, a signature method 316 for defining a workflow by which signatures are added to the report. The catalog 321 of the report content item is the same as the catalog of other capture data item types, which are filled only when data are available in the instance data element 312. Table 6 shows an example of the attribute values (vstring) extracted from the instance data element 312 of the report content item and copied into the catalog 321 of that content item.

TABLE 6

| COLUMN | ATTRIBUTENAME | VSTRING |
|---|---|---|
| 1 | printDataType | XPS |
| 3 | printDttm | 2012/03/20 11:22:08.496 . . . |
| 19 | userID | 4501A0061D2D4CE3AAB6 . . . |

Report content items do not define a sections data element 313.

As will be appreciated by one skilled in the art, aspects of the present invention may be embodied as a system, method, and computer program product. Thus, aspects of the present invention may be embodied entirely in hardware, entirely in software (including, but not limited to, firmware, program code, resident software, microcode), or in a combination of hardware and software. All such embodiments may generally be referred to herein as a circuit, a module, or a system. In addition, aspects of the present invention may be in the form of a computer program product embodied in one or more computer readable media having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wired, optical fiber cable, radio frequency (RF), etc. or any suitable combination thereof.

Computer program code for carrying out operations for aspects of the present invention may be written in any combination of one or more programming languages, including an object oriented programming language such as JAVA, Smalltalk, C#, C++, and Visual C++ or the like and conventional procedural programming languages, such as the C and Pascal programming languages or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The program code may execute entirely on a user's computer, partly on the user's computer, as a stand-alone software package, partly on the user's computer and partly on a remote computer or entirely on a remote computer or server. Any such remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Any flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It is be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed.

While the invention has been shown and described with reference to specific preferred embodiments, it should be understood by those skilled in the art that various changes in form and detail may be made therein without departing from the spirit and scope of the invention as defined by the following claims.

What is claimed is:

1. A method of processing data, comprising:
defining, by a processor, a task related to performing an operation with data in a data information system; and
storing the definition of the task and the data with which the task operates as separate content items in memory, each content item having a data format that complies with a same unified data structure.

2. The method of claim 1, wherein the content item corresponding to the task further comprises a stream data element that references the content item corresponding to the data and incorporates the data into the content item corresponding to the task.

3. The method of claim 1, wherein the content item corresponding to the task includes an instance data element having fields specific to the content item corresponding to the task and a catalog data element having a copy of data extracted from the fields of the instance data element.

4. The method of claim 1, wherein the content item corresponding to the definition of the task further comprises a streams data element that includes binary data.

5. The method of claim 1, wherein the content item corresponding to the definition of the task further comprises a sections data element that includes data corresponding to a processed analysis.

6. The method of claim 1, wherein the content item corresponding to the definition of the task further comprises a signature data element that includes an electronic signature.

7. The method of claim 1, wherein the task is a reporting method that defines an appearance and content of a report.

8. The method of claim 1, wherein the task is a signature method that defines a workflow for applying an electronic signature to the content item corresponding to the task.

9. The method of claim 1, wherein the task is an analysis method that defines a workflow for performing an analysis.

10. A data information system comprising:
memory storing a first content item representing a predefined workflow, the first content item having a data format that complies with a unified data structure;
a scientific instrument configured to acquire data in accordance with the predefined workflow; and
a server in communication with the scientific instrument to obtain the data acquired by the scientific instrument, the server having a processor that executes program code to convert the acquired data into a second content item with a data format that complies with the unified data structure.

11. The data information system of claim 10, wherein the content item corresponding to the task further comprises a stream data element that references the content item corresponding to the data and incorporates the data into the content item corresponding to the task.

12. The data information system of claim 10, wherein the content item corresponding to the task includes an instance data element having fields specific to the content item corresponding to the task and a catalog data element having a copy of data extracted from the fields of the instance data element.

13. The data information system of claim 10, wherein the content item corresponding to the definition of the task further comprises a streams data element that includes binary data.

14. The data information system of claim 10, wherein the content item corresponding to the definition of the task further comprises a sections data element that includes data corresponding to a processed analysis.

15. The data information system of claim 10, wherein the content item corresponding to the definition of the task further comprises a signature data element that includes an electronic signature.

16. The data information system of claim 10, wherein the task is a reporting method that defines an appearance and content of a report.

17. The data information system of claim 10, wherein the task is a signature method that defines a workflow for applying an electronic signature to the content item corresponding to the task.

18. The data information system of claim 10, wherein the task is an analysis method that defines a workflow for performing an analysis.

19. A computer program product for processing data, the computer program product comprising:
a computer-readable storage medium having computer-readable program code embodied therein, the computer-readable program code comprising:
computer-readable program code configured to define, when executed by a processor, a task related to performing an operation with data in a data information system; and
computer-readable program code configured to store, when executed by the processor, the definition of the task and the data with which the task operates as separate content items in memory, each content item having a data format that complies with a same unified data structure.

20. A computer-readable storage medium for storing content items used by an application program being executed on a data information system, the computer-readable storage medium being encoded with a unified data structure to be used to define a data format for each of the content items in the data information system, the unified data structure comprising:
an instance data element having fields that are specific to a content item; and
a catalog data element having a copy of data extracted from the content item-specific fields of the instance data element.
